(19) United States
(12) Patent Application Publication
(10) Pub. No.: US 2011/0217950 A1
(43) Pub. Date: Sep. 8, 2011

(54) Apparatus & method to improve pairing security in Bluetooth™ headsets & earbuds

(76) Inventor: Alan Kozlay, Timonium, MD (US)

(21) Appl. No.: 12/932,810

(22) Filed: Mar. 7, 2011

Related U.S. Application Data
(60) Provisional application No. 61/282,619, filed on Mar. 5, 2010.

(51) Int. Cl. H04W 12/04

(52) U.S. Cl. 455/410

(57) ABSTRACT

The invention disclosed provides an improved Bluetooth™ system with increased security and privacy for “device association” (“pairing”) of two Bluetooth™ devices where one device has no display. Heretofore, only Secure Simple Pairing (SSP) Association Model “Just Works” is used if one device is display-less. Unfortunately, Just Works is vulnerable to exploits known as “Man-In-The-Middle” (MITM) attacks. By contrast, my invention implements uses Numeric Comparison (heretofore, unusable when one of the pairing devices are display-less). Numeric Comparison is more secure than Just Works, because both agree to a randomly-generated 6-digit number. My innovation allows display-less Bluetooth™ devices (headsets or ear buds) to pair with display-bearing devices, because the matching 6-digit number on the displaying device is “spoken” or sounded (voice recordings, beeps, tones) into a displayless device user's ear. This allows displayless device users to hear sounds (spoken or beeped) equivalent to displayed 6-digit numbers to facilitate comparison, matching, and secure Bluetooth pairing. This reduces or eliminates risk of MITM exploits.

### PRIORITY OF PROVISIONAL PATENT APPLICATION

This application is a Regular patent application to replace my U.S. Provisional Patent Application Ser. No. 61/282,619 filed Mar. 5, 2010. This Regular patent application claims priority based upon said Application Ser. No. 61/282,619.

### 1. FIELD OF THE INVENTION

The field of the invention relates to wireless Bluetooth™ communications security. More particularly, the field of the invention relates to increasing wireless communication security during pairing (device association) of “display-less”, wireless Bluetooth™ equipped ear buds and headsets (and other display-less Bluetooth devices) with Bluetooth devices having a display (“display-bearing”) e.g., cellphones, PDAs, etc.

### 2. BACKGROUND TECHNOLOGY OF THE INVENTION

A variety of electronic devices are enabled for wireless communication between and among each other using one or more standardized wireless communication protocols. One of the most popular wireless communication protocols currently on the market in wide use is the Bluetooth™ wireless protocol for device association.

The Bluetooth™ wireless communication protocol is used for exchanging data and for “device association”—aka, “device pairing”—of two Bluetooth devices, over short distances via radio wave transmission. Both fixed and mobile devices can use Bluetooth. This facilitates creating (close-by) personal area networks (PANs). PANs generally are office, home, car, or mobile networks that are used by one person or a few people operating and communicating in a very near-by working area.

Bluetooth™ wireless devices can be associated—i.e., connected and paired together—by first exchanging shared, verifiable information wirelessly, to enable the subject wireless devices to “trust” each other, prior to establishing interactive sessions conducted via open Bluetooth™ wireless radio communications.

The “Man-In-The-Middle Attack” (MITM) is a well-known and understood hacker exploit. MITM is an attack by a rogue device which attempts to insinuate itself into the legitimate Bluetooth™ “trust dialogue” during pairing. While the two victim devices are attempting to discover (find) each other and pair (interactively communicate) with each other for the first time, an attacker's rogue device in between the two legitimate devices attempts to respond to both of the victims' devices in order to compel them both to believe they have found each others' (legitimate) device, when, in fact, they're only each communicating with and/or through the attacker's rogue device (which then facilitates indirect communication between the two victim devices through the rogue intermediary). In this way, the attacker's device gains full trust from both devices. Full trust allows an attacker to do many harmful things including eavesdropping on the communications and taking remote control of the victim devices for nefarious or other unauthorized purposes.

Many recently-manufactured Bluetooth™ devices pair using a new mechanism first introduced in Bluetooth™ Revision 2.1 known as Secure Simple Pairing (SSP).

SSP introduces four Association Models for pairing and they are: Pass Key Entry, Out-Of-Bounds (OOB), Numeric Comparison and an association option in the Bluetooth standard known as “Just Works”.

The choice of which model is used is based on the input and output capabilities of the two devices to be paired. The first three models (Pass Key Entry, OOB and Numeric Comparison) provide protection against the MITM attack, whereas the Just Works model does not. This is because the Just Works model is used when there is no display for output and no keyboard for numerical input on at least one of the two devices and, therefore, it provides no mechanism to verify that the two devices are communicating directly with each other instead of through an attacking device. For example, the Numeric Comparison model is used when both devices have a display for output. It is assumed that a minimal set of buttons is available to the user to be used to convey a confirmation by the user. Both devices calculate a random 6 digit number (known as the User Confirmation Value) that only the two devices could know and both devices display the number on the screen. The User must compare the numbers shown on each screen to ensure they match and press a button on both devices to confirm in order to allow pairing to continue. An attacking MITM device cannot mathematically cause the same 6 digit number to be generated between itself and each of the victim devices: thus, they would not match.

Traditional Bluetooth headsets and ear buds do not have a display for output or a keyboard for numeric input or an alternative communications medium to facilitate trust exchange. Heretofore, the Just Works model has been the only appropriate model to use in these cases.

The Just Works model begins just as the Numeric Comparison model does by generating the 6 digit number but, since there is no display for output. Just Works assumes user confirmation and proceeds with pairing without actual user confirmation. Without the user confirmation of the 6 digit number, Just Works model is vulnerable to the MITM attack.

### NECESSITY OF THE INVENTION

Therefore, it appears there is a need in the industry for introducing better and more dependable security in Bluetooth headsets and ear buds. There is likely a large latent user demand for dependable security in Bluetooth headsets and earbud devices. Accordingly, it is expected that the present invention disclosed herein is unique and useful and non-obvious, given its creation of an innovative solution to facilitate a Numeric Comparison association model implementation for platform devices and headsets and ear buds that do not have a display for output.

Additionally, as we today experience and observe exponentially-increasing security concerns in the wake of increasing numbers of hacker exploits, it appears obvious that the present invention is needed in the industry and on the market.

### 3. OBJECTS OF THE INVENTION

Accordingly, it is one primary object of the present invention, to provision Bluetooth™ (or higher) headsets and earbuds with the capacity to securely and predictably complete device association (pairing) using the more-secure “Numeric Comparison” association model, rather than using the “Just Works” model traditionally employed in Bluetooth™ 2.1 pairing with wireless (but display-less) headsets and earbuds.

It is a related primary object of the invention to create a method of voice-based Bluetooth security for device association (pairing). This is accomplished by facilitating an allowing the display-less and keyboard-less user's comparison of the 6-digit number, e.g., in their headsets and/or ear buds. Typically, the technique involves implementing a means for converting the random 6-digit number into audio indicia, e.g., wherein a recorded or synthesized voice stored in memory e.g., “speaks” and/or “beeps” or sounds tones representative of the 6-digit number. This allows the display-less user to conduct “numeric comparison”, insofar as the user hears recorded speech, and/or a sequence of beeps or tones sounded into his ear by the headset's or earbud's speaker. This allows the user to use such audio indicia, to compare sounded equivalents of the display-bearing device's 6-digit number, merely by listening to equivalent representation of the 6-digit number on his device before allowing the pairing to proceed.

Yet another primary object of the invention is to decrease or eliminate susceptibility and exposure to “Man-In-The-Middle” attacks for display-less devices.

### 4. RELATED ART

The published US Patent Application 20090228707 to Linsky discloses “Image-Based Man-In-The-Middle Protection in Numeric Comparison Association Models”. Although the subject patent application appears useful for image comparison purposes, it is unlike the present invention in that it uses images in attempts to preclude so-called “Man-In-The-Middle” attacks against Bluetooth™ devices.

In the Linsky application, an authentication scheme is provided for securely establishing an association with a second device over a wireless communication link. A cryptographic key exchange is performed between a first device and a second device, wherein cryptographic information for the first and second device is obtained. The first and second devices may independently generate a confirmation value based on the cryptographic information. Each device may obtain a confirmation image based on their respective confirmation values. A confirmation image is uniquely associated with a confirmation value so that no two confirmation values can be associated with the same confirmation image.

The images for both the first and second devices are provided to an operator for authentication. If the confirmation images are identical, an association between the first and second devices may be confirmed by the operator. Comparing confirmation images may increase the reliability of operator authentication and is more efficient than comparing values.

Linsky claims what Bluetooth™ SSP does but with the change that, instead of user looking at the display on each device to compare numbers displayed, the display would show images to be compared. Presumably enough different images would exist to provide sufficient possibilities. But, Linsky is not comparable to the present invention because his images still require a display.

Although there are other devices relating to Bluetooth™ headsets and ear buds, it does not currently appear that there are any other art that's directly-comparable to that disclosed as the present invention as relates to Bluetooth 2.1 (or higher) headsets/ear buds.

### Comparing Numeric Comparison and Just Works Association Models

Secure Simple Pairing uses four association models referred to as Numeric Comparison, Just Works, Out Of Band, and Passkey Entry. Two association models are described in more detail in the following sections. The association model used is based on I/O capabilities of the two devices. (From Bluetooth™ 2.1 Specification)

### Numeric Comparison:

The Numeric Comparison association model is designed for scenarios where both devices are capable of displaying a six digit number and both are capable of having the user enter “yes” or “no”. A good example of this model is the cell phone/PC scenario. The user is shown a six digit number (from “000000” to “999999”) on both displays and then asked whether the numbers are the same on both devices. If “yes” is entered on both devices, the pairing is successful. (From Bluetooth™ 2.1 Specification)

The numeric comparison serves two purposes. First, since many devices do not have unique names, it provides confirmation to the user that the correct devices are connected with each other. Second, the numeric comparison provides protection against MITM attacks. Note that there is a significant difference from a cryptographic point of view between Numeric Comparison and the PIN entry model used by Bluetooth Core Specification and earlier versions. In the Numeric Comparison association model, the six digit number is an artifact of the security algorithm and not an input to it, as is the case in the Bluetooth security model. Knowing the displayed number is of no benefit in decrypting the encoded data exchanged between the two devices. (From Bluetooth™ 2.1 Specification)

### Just Works:

The Just Works association model is primarily designed for scenarios where at least one of the devices does not have a display capable of displaying a six digit number nor does it have a keyboard capable of entering six decimal digits. A good example of this model is the cell phone/mono headset scenario where most headsets do not have a display. The Just Works association model uses the Numeric Comparison protocol but the user is never shown a number and the application may simply ask the user to accept the connection (exact implementation is up to the end product manufacturer). The Just Works association model provides the same protection as the Numeric Comparison association model against passive eavesdropping but offers no protection against the MITM attack. (From Bluetooth™ 2.1 Specification)

NB: The above comparisons are quotations from the Bluetooth 2.1 Specification.

### SUMMARY OF THE INVENTION

The present invention disclosed herein provides a means of implementing higher security assurance than is now provided by the Just Works model described above. The improvement of the invention comprises an apparatus and a method which employs the Bluetooth™ 2.1 Numeric Comparison association model to provide new and additional security. With my invention, additional security can be established between a display-bearing device (e.g., a cellphone, Blackberry, or other PDA with display and keyboard), and a display-less device (e.g., to a prospective pairing headset and/or earbud), instead of using the much-less-secure Just Works pairing method (now common practice).

Wireless Bluetooth™ 2.1 headsets and/or earbuds did not (and still do not) have a screen display means to allow the user to visually-verify the generated and displayed 6-digit number (so earbuds and headsets currently use Just Works instead of using Numeric Comparison).

By contrast, the present invention's innovation is to functionally provide an output means for the 6-digit number (in lieu of or in addition to a display), on one or both devices, by means of having the 6-digit number “spoken” by recorded or synthesized voice (or represented by other predetermined acoustic indicia, e.g., long and/or short beeps, audio tones, melodic tones, etc.) which comprises audio conducted into the user's ear.

Thus, my invention improves security because Numeric Comparison can be implemented in Bluetooth 2.1™ (or higher) headsets and ear buds by audio means.

Additionally, the user's confirmation of the 6-digits matching can either be effectuated by simple button press or vocally, such as “yes” or “no” to a voice pattern recognition engine for additional security and/or other acceptance actuation component. In summary, the innovation of the invention is to allow better security for Bluetooth™ 2.1 (or higher) headsets and ear buds using Numeric Comparison pairing instead of Just Works.

Numerical Comparison requires that the user confirm on both devices before pairing will continue. The user can convey confirmation through button push, voice recognition, or other indicator. If the user decides to reject the pairing process due to unmatched number or any other reason, the user can convey the rejection directly through button push or voice recognition or by timeout without confirmation.

The headset or ear bud that is expecting user confirmation (of a match of the 6 digit number for comparison via audio into the user's ear) can expect confirmation after each digit is sounded or one time after all 6 digits are sounded.

Accordingly, the present invention as disclosed herein has been shown to provide an apparatus and a method for a more secure pairing of Bluetooth™ 2.1 (or higher) headsets and ear buds with their Bluetooth-connected cell phones, PDAs, and other connectable communications platform devices, through facilitating Numeric Comparison Association model than can be achieved through the Just Works Association Model.

The apparatus is provisioned by implementing into ear buds and headsets of the present invention a circuit with embedded components including a processor having a non-volatile memory, a voice synthesizer, a speaker, and at least one control button, in addition to implementing the standard transceiver components needed for deploying Bluetooth™ wireless communications between a platform Bluetooth™ 2.1 (or higher) device and a Bluetooth™ 2.1 (or higher) headset or ear bud. Many of these components will be available within in the ear bud design. Effectively, the invention provides means for accepting and verifying that a 6-digit string of numbers output on a remote device exactly matches a 6-digit string of numbers sent acoustically from the user's earpiece. To implement security, the apparatus retrieves digit representations from memory and “speaks” into a user's ear, which is taken from the 6-digit sequence of 6 numeric digits from the set {0, 1, 2, 3, 4, 5, 6, 7, 8, 9}.

### DETAILED DISCUSSION OF THE INVENTION

### Description of the Figures

FIG. 1: Pairing Sequences between a Display-bearing Device and a Display-less Device

### REFERENCE NUMERALS

100 Bluetooth Device with display—Cellular Phone Shown
102 Example of User Confirmation Value 397031 being displayed
104 Bluetooth Device without display—Bluetooth Ear Bud Shown
106 Sound emanating from Earbud—example speaking 397031
108 Bluetooth Simple Pairing Steps 1-6 of the Bluetooth Specification V2.1
110 Bluetooth Simple Pairing Step 7 of the Bluetooth Specification V2.1 (Numeric Comparison)
112 Device Displays a 6 Digit User Confirmation Value, User Presses Button if Values Agree
114 Audio Device Speaks a 6 Digit User Confirmation Value, User Presses Button if Values Agree
116 Bluetooth Simple Pairing Steps 8-11 of the Bluetooth Specification V2.1 to complete pairing

### DESCRIPTION OF ONE PREFERRED EMBODIMENT OF THE INVENTION

While this invention is described in the preferred embodiments, changes can be made without departing from the scope and spirit of the invention, as described in the claims section.

This invention addresses the security of pairing devices in which one of the device pair has no display screen and therefore cannot display a User Confirmation Value (the 6-digit number). Note that the steps of the Bluetooth pairing procedure described below refer to Section 4.2 (page 700) of the Bluetooth Specification V2.1 and the Numeric Comparison step is described on pages 704/705 of that document which is fully included in this disclosure.

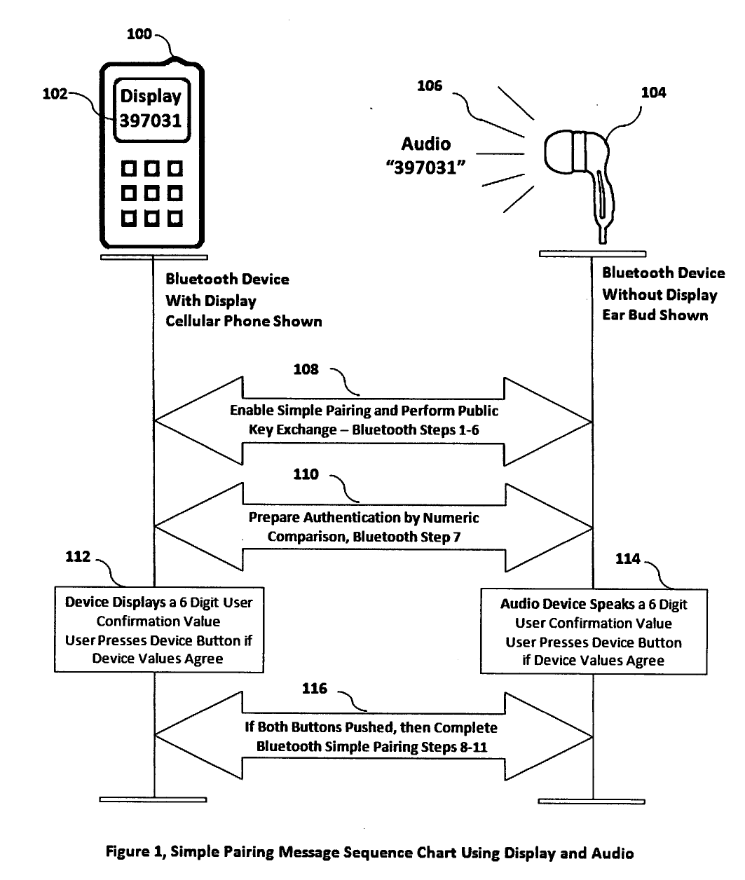

FIG. 1 is a sequence chart describing the basic data exchanges for Secure Simple Pairing. The vertical line on the left represents events relating to the Cellular Phone 100 and the vertical line on the right represents events relating to the Bluetooth Ear Bud device 104.

In FIG. 1, Simple Pairing Message Sequence Chart Using Audio as Disclosed, a Bluetooth Phone or other device with a display capability) 100 is shown and a Bluetooth Ear Bud (or other Bluetooth Device without a display capability) 104 is to be paired with it. These two Bluetooth devices are placed in the standard Bluetooth mode to discover each other and begin an exchange of information to begin the pairing process. Bluetooth Simple Pairing 108 Steps 1-6 of the Bluetooth Specification V2.1 are performed and the devices prepare to authenticate themselves to ensure that they are the devices that the user intended to use and not a third device. The Ear Bud 104 will assert that it can display the User Confirmation Value (6 digits) and both devices proceed to Bluetooth Simple Pairing Step 7, Prepare for Numeric Comparison 110.

At this point, the Bluetooth Cellular Phone 100 will display the User Confirmation Value 102 in accordance with the Bluetooth Standard. However, to implement the present invention, the Bluetooth Ear Bud 104 will electronically generate sounds to “speak” the numbers 106 on its earpiece speaker so that the user can hear the number.

If the displayed number 102 and the audio spoken number 106 match, then a button (not shown) will be pushed by the user(s) on both devices to continue the simple pairing process. Alternatively, the Ear Bud 104 may be constructed to accept a voice response “yes” or “no” (not shown) in lieu of pressing or not pressing a button. Note that in the example of FIG. 1, the displayed number 397031 matches the audio numbers 397031, so the user would press the button on both devices to authenticate their identity. Note that the spoken number 106 is not part of the Bluetooth standard, but, using this invention can be implemented without violating the standard.

When the user(s) push both buttons, then the Bluetooth Simple Pairing 116 Steps 8-11 of Bluetooth Specification V2.1 are completed and this completes the pairing process, thereby enabling the devices to be used.

While there are other Bluetooth devices in the marketplace that contemplate additional security, there does not appear to be comparable apparatuses or methods in the art that would precede the present invention disclosed herein. Furthermore, as one skilled in the art reviews this disclosure, it will be obvious how various aspects of the present invention can be combined or rearranged such that new systems integrations thereof will be apparent. The undersigned Inventor is aware of these implications and expressly asserts that all have been considered and that there are many ways the present invention can be implemented according to the spirit of the invention herein. Inventor reserves the right to claim any and all useful implementations or concepts suggested by the present invention.

I claim:

1. A method of wirelessly pairing two electronic devices, wherein a first device has a display and wherein a second device has no display, comprising the steps of:
a user actuating a button on at least one of said devices to initiate pairing—or in the alternate, if at least one of said devices includes means for automatic pairing, said at least one device automatically actuates and initiates pairing;
after at least one of button-actuated initiating of pairing and automatic-actuated initiating of pairing occurs, pairing is completed in steps further comprising:
the two said electronic devices execute the first seven (7) steps of the Simple Pairing Message Sequence published in Bluetooth Specification Version 2.1+EDR [volume 2, page 700] up to the point at which the Device Authentication options are executed at step 7a, and
said first device enters the Numeric Comparison mode and generates and displays a 6-digit number on its display, and
said second device also enters said Numeric Comparison mode and generates, then “speaks” the first-device-displayed 6-digit number via its audio speaker into the ear of a user the audio indicia equivalent to said displayed random 6-digit number, and
when said user recognizes that said first-device-displayed 6-digit number and said audio indicia spoken into the ear of said user equivalent to said displayed 6-digit number match, then said user again actuates a button on each device to cause Bluetooth to complete pairing of said first and said second device.

2. The method of claim 1, wherein said user—upon recognizing that said 6-digit numbers match—verbally acknowledges to said first device that said first device is recognized by said second device in lieu of said user pressing a button on at least one of said first device and said second device.

3. A display-bearing Bluetooth apparatus adapted for device association with a display-less Bluetooth apparatus, wherein:
said display-bearing apparatus includes means to generate and display a 6-digit number according to SSP Numeric Comparison protocol, and wherein said apparatus is adapted to transmit said 6-digit number (or intelligible signals indicative thereof) to said display-less Bluetooth device;
and wherein:
said display-less apparatus includes means to convert said transmitted 6-digit number (or intelligible signals indicative thereof) into audio indicia for sounding into the ear of a user so he can determine that said audio indicia represent and match said transmitted 6-digit number.

4. The Wireless Bluetooth™ headset and/or ear bud apparatus of claim 3, where said electronic components include a microphone and processor with a program capable of recognizing an acknowledgement command, such as “yes” in lieu of pressing a button to accept the pairing.
